(19) United States
(12) Patent Application Publication
(10) Pub. No.: US 2004/0069851 A1
(43) Pub. Date: Apr. 15, 2004

(54) Radio frequency identification reader with removable media

(76) Inventors: Mitchell B. Grunes, Minneapolis, MN (US); David T. Berquist, St. Paul, MN (US)

Correspondence Address: 3M INNOVATIVE PROPERTIES COMPANY, P.O. BOX 33427, ST. PAUL, MN, 55133-3427, US

(21) Appl. No.: 10/470,446

(22) PCT Filed: Mar. 13, 2001
(86) PCT No.: PCT/US01/07979

(51) Int. Cl. G06K 7/00

(52) U.S. Cl. 235/435

(57) ABSTRACT

The present invention includes a variety of improvements in RFID readers, one of which is the use of a removable, and preferably non-volatile, date storage medium with the RFID reader to facilitate the transfer of data to the RFID reader, from the RFID reader, or both. This enables a user to receive real-time information related to items being interrogated by the RFID reader, which is a considerable advantage when compared to conventional RFID readers. The RFID reader of the present invention may also have a user interface having one or more features, and may be used in connection with several methods for using an RFID reader including searching for an RFID-tagged item of interest

### TECHNICAL FIELD

present invention relates to improvements in radio frequency identification (RFID) interrogators or readers, of the kind that can be used to interrogate RFID tags to obtain information from those tags about the object to which they are attached.

### BACKGROUND OF THE INVENTION

RFID interrogators, or readers, are used to interrogate RFID tags associated with objects to provide a user with information concerning that object. For example, an RFID reader can be used to interrogate RFID tags associated with library books to determine, for example, whether the books are in the proper order, or whether a particular book of interest is located in the area interrogated by the reader. RFID readers have been proposed for a number of other uses, as is illustrated in the literature, but few improvements in such readers appear to have been offered. The present invention relates to improvements in RFID readers that interrogate RFID tags.

### SUMMARY OF THE INVENTION

The present invention includes a variety of improvements in RFID readers, one of which is the use of a removable, and preferably non-volatile, data storage medium with the RFID reader to facilitate the transfer of data to the RFID reader, from the RFID reader, or both. This enables a user to receive real-time information related to items being interrogated by the RFID reader, which is a considerable advantage when compared to conventional RFID readers. The RFID reader of the present invention may also have a user interface having one or more features, and may be used in connection with several methods for using an RFID reader including searching for an RFID-tagged item of interest. These and other features of the invention are described in much greater detail below.

### BRIEF DESCRIPTION OF THE DRAWINGS

The present invention will be described with reference to the appended Figures, in which FIG. 1 is an elevated side view of an RFID reader according to the present invention;

FIG. 2 is an elevated side view of an RFID reader according to the present invention with a data storage medium being removed by a user;

FIG. 3 is a rear view of a handheld computer for use with an RFID reader according to the present invention;

FIG. 4 is a schematic diagram of a handheld computer with certain connections to facilitate its use in an RFID reader according to the present invention;

FIG. 5 is an elevated side view of a pack that may be tethered to an RFID reader according to the present invention;

FIG. 6 is an exploded view of an embodiment of a battery shoe, power management circuit, an RFID reader hardware according to the present invention;

FIG. 7 is an elevated side view of a battery and recharging station;

FIG. 8 is a side view of a drive with a removable data storage medium operatively connected thereto, in accordance with the present invention; and

FIG. 9 is a top view of a removable data storage medium according to the present invention.

### DETAILED DESCRIPTION OF THE INVENTION

The RFID reader described herein is one component of an RFID interrogation system that may be used for various different applications. Thus, although the description of the present invention may focus in some respects on the reader itself, and in some respects on the use of the reader in an environment (such as a library) for the detection of RFID tags associated with items (such as library materials), the invention has broad applicability in RFID systems and uses. Also, the term “reader” may be used generally to describe an RFID device that includes RFID interrogator or reader hardware, though it may also include other subsystems such as an RFID tag programmer (or “writer”). Thus, an RFID reader (used to describe the entire device, and generally shown in the attached Figures as reference number 10) may both read from, and program or write information to, an RFID tag in accordance with the present invention.

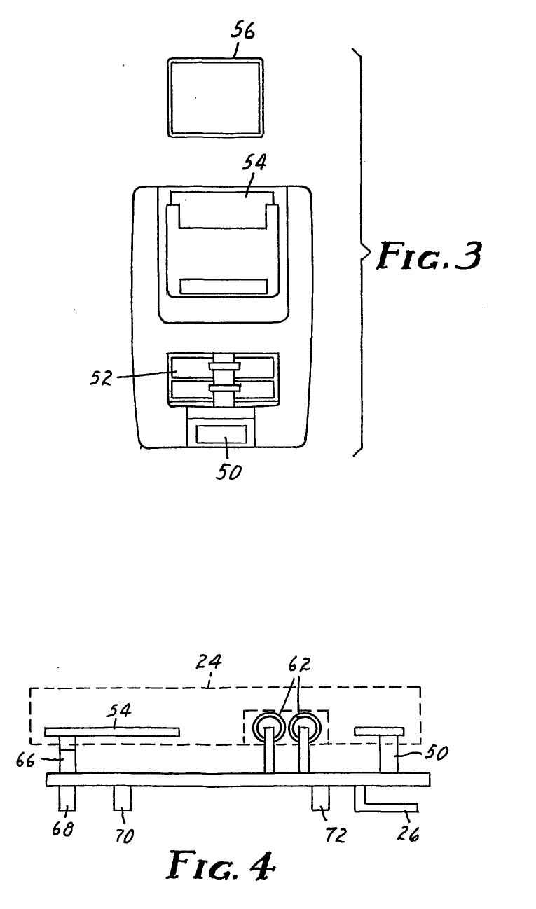

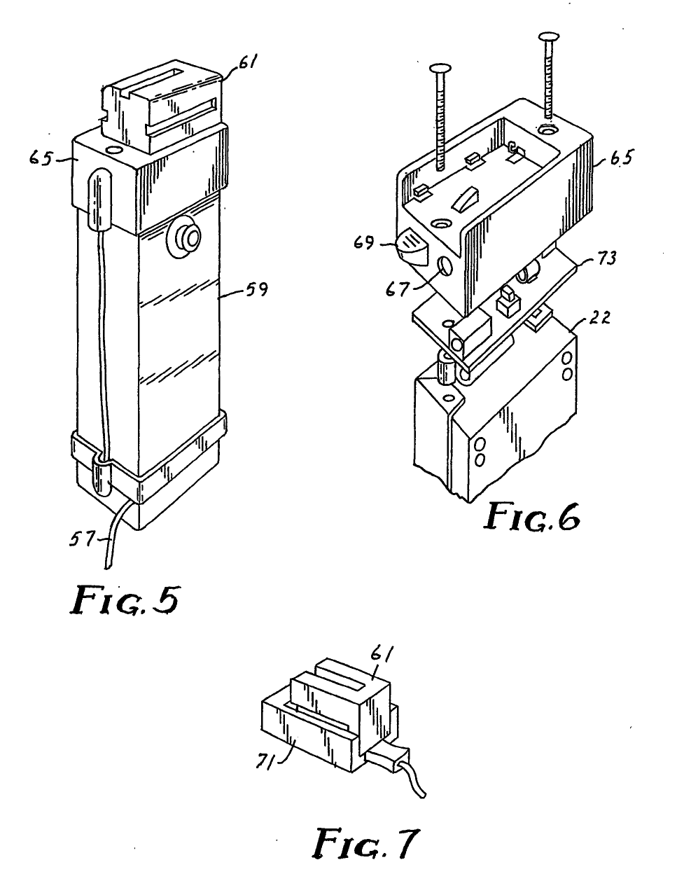

An RFID reader 10 according to the present invention is preferably portable, and as shown in FIG. 1 can include a body 12 and handle 14, a power supply (either integral with the reader within, for example, the handle, or in a pack as shown in FIG. 5 that may be worn by the user and tethered to the reader), an antenna 16 that is preferably contained within an antenna housing 17, an RFID reader hardware 22 for emitting and receiving RFID signals, which may be positioned adjacent the antenna or located elsewhere (including in a pack) and operatively connected to the antenna, and a user interface. The RFID reader hardware may be activated by a trigger 20 to interrogate an RFID tag. Trigger 20 may also be used for other functions, such as assisting the user in resetting the processor, setting or resetting certain information (such as the date and time), or other similar functions. The RFID reader is able through known signal processing techniques to send a signal to an RFID tag, to receive a signal from that tag and interpret the information represented by the signal, and to provide information to the user through a user interface.

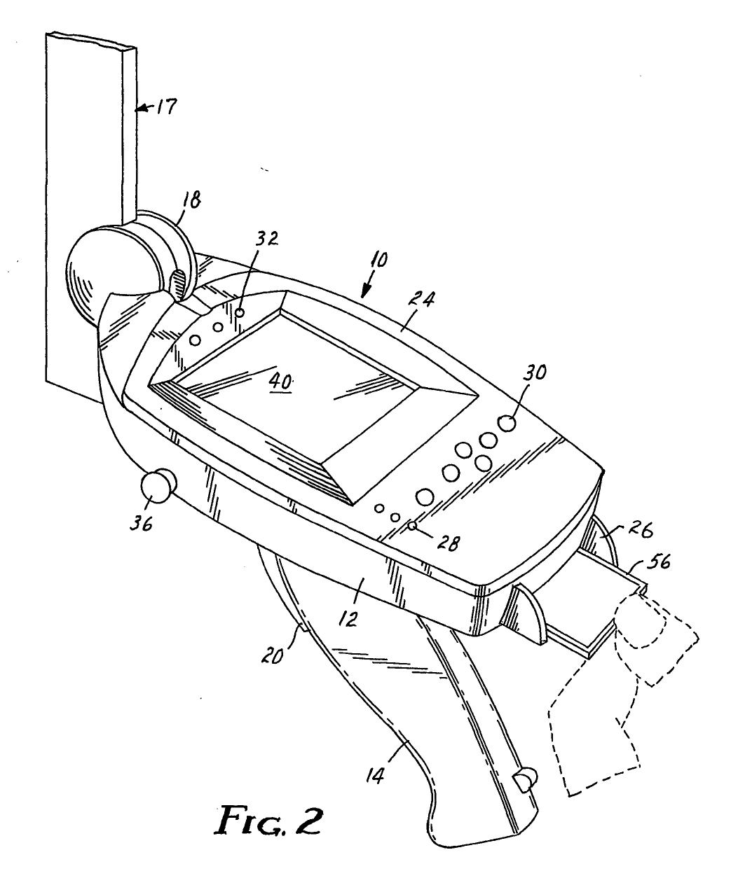

The display 40 may be selected from among suitable displays, and may be a screen that can be activated by the touch of a user's finger, or with a stylus, for example. The display may be part of a handheld computer 24, or personal digital assistant, of the type available from Technology Resource Group (TRG) of Des Moines, Iowa, or at “www.trgpro.com” under the designation “TRGPRO™,” for example, or may be separate from the processor. The handheld computer 24 (or the RFID reader) may also include user-operable function keys 30, which may be programmed to perform a specific function or set or series of functions when activated by a user. The RFID reader may also include one or more unobtrusive buttons, holes, or other activation points 28 that the user can use to reset or change certain settings on the RFID reader. For example, a hole that is sized to permit insertion of only a thin object such as a pin or the end of a paperclip may overlie a button that deactivates or reactivates the RFID reader. The activation point may enable the user to change information such as the date and time kept by the processor, and the like. The handheld computer may also include, as shown in FIG. 3, a serial port 50, a location for receiving batteries 52, or a port 54 for receiving removable media 56 in the manner described below.

The power source should be sufficient to power the unit (including the display, the processor, the emitter/receiver for emitting and receiving RFID signals, and any sound or light generation source of the type described below), preferably without adding so much weight as to make the unit cumbersome. The power source could be a battery, and preferably a rechargeable battery, and can be integral with the RFID reader (in the handle, for example) or connected via a tether power cord to, for example, a pack 59 containing a power source, which pack can be worn around a user's waist or hung from a user's shoulder. Pack 59 could also include other components, such as various power management devices, the processor, memory, the RFID reader or writer hardware, or some combination of the foregoing. The RFID reader could even be powered by standard alternating current, although the cord might interfere with the user's mobility. One suitable type of rechargeable battery is a lithium-ion battery of the type normally used in a video camera. If the battery is tethered to the RFID reader, then as described below, it may be necessary or desirable not only to have a power line connecting them together, but also other lines to enable the processor to control the power, to monitor the battery power level, and the like.

The database and processor may be selected to support the functions to be achieved by the RFID reader. The database may include, for example, a list of the identifying number or characteristics of RFID tags that are expected to be interrogated, and may be configured to match the identification code of the RFID tag that has been interrogated to the identity of the item of interest, or to a class of items to which the item belongs, or to a list of one or more specific items in which the user is interested, for example. At least some memory may be integral with the processor, and thus the processor can store and access at least some of the information that may be desired by a user, with the additional information being available on a separate database with which the portable RFID reader can exchange information. This may enable a user to search RFID tags in real time for some information that is available directly from the RFID tag, to obtain other information from memory associated with the processor, other information from removable memory of the type described in detail below, and/or other information from a database separate from the RFID reader and pack.

Antenna 16 is preferably a loop antenna, but may be selected from among any suitable antennae that facilitate the transfer of information between the RFID tag and the RFID reader. The antenna (either the same or a different antenna) can also be used to transfer information to the RFID tag in applications where the system is capable of both reading from and writing to the tag. The form factor of the antenna and the materials from which it is constructed may be selected by a person of ordinary skill in the art, and may depend on factors including the distance (read range) at which data transfer is likely to occur, the characteristics of the RFID tags, and the particular characteristics of any signals emitted by the RFID reader. In one embodiment, the antenna may be carried within an antenna housing as shown in FIG. 1, and that housing may be pivotably mounted to the body 12 of the RFID reader. Any electrical or other connection passing through the pivot point would be made suitably flexible or small to avoid unnecessary damage from bending as the antenna housing is moved about the pivot point. The pivot point may enable the antenna to align more readily with the orientation of the objects bearing RFID tags that the RFID reader is interrogating.

The RFID reader has a user interface, typically including the display, but also may include lights, one or more ways to enter information by other than RFID interrogation, or a speaker for transmitting sounds. These and other aspects of a user interface such as those described in copending U.S. application Ser. No. 09/755,714, filed Jan. 5, 2001 and entitled “User Interface for Portable RFID Reader” (the contents of which is incorporated by reference herein) may be used with the RFID reader of the present invention. Other components of the RFID device may include an infrared receiver, or a recharging or other type of port 36.

Certain components may be tethered by one or more cables, wires, or other connection devices to an RFID reader 10. For example, as mentioned elsewhere, it may be desirable to place a battery 61 on or in a pack 59 that the user can carry on the user's waist. It may also be desirable to tether other components, such as the RFID reader hardware 22. For example, both the battery 61 (received in battery shoe 65) and the RFID reader hardware 22 may be provided in a pack 59 that is tethered by tether 57 to an RFID reader 10 that includes a processor that normally operates using several small batteries inserted into the back of the processor, which may be, for example, the TRGPRO™ referenced herein. The tether (connection) may include:

a data receiving line connecting the RFID reader hardware to the processor;

a data transmission line that connects the processor to the RFID reader hardware;

a voltage conversion line that, in combination with a power conversion circuit board transforms the battery power from the tethered pack to power that simulates the small batteries normally used in the processor, and thus connects the battery to the processor;

a reader power-on control line that converts battery voltage to that required to power the reader (for example from 8.3 volts to 12.5 volts);

a battery level indicator line that provides information to the processor indicating the level of power remaining in the battery or batteries (for example from 0 to 100% of full battery power), which can enable that information to be displayed on the display;

a power verification line, to verify that correct power is being supplied from reader is turned off;

other lines, such as those used on the power circuit board on the tethered pack to create the power for the processor, and/or to ground to avoid external noise during operations, and other such lines.

These lines need not all be separate, and it may be possible to multiplex signals related to more than one function on a single line that tethers the RFID reader to the pack. The particular lines or kinds of information transmitted between an RFID reader and a tethered pack depend, of course, of the components located in each, and thus can be designed as desired by one of ordinary skill in the art.

The battery 61 or battery shoe 65 may include a direct recharging portal 67 and a battery release 69, to permit the battery to be removed and recharged in recharger 71. The battery and battery shoe may also be connected to or include a power management circuit 73, which in the embodiment illustrate in FIG. 6 is interposed between the battery shoe 65 and the RFID reader hardware 22.

FIG. 4 is a schematic diagram of one embodiment of a handheld computer 24 adapted to interface with and be a component of an RFID) reader. Serial port 50 and removable media port 54 may be provided, as well as connections to battery terminals 62 that enable a tethered battery to provide power through battery connection 70 (which might normally receive, for example, multiple AA or AAA batteries) to the handheld computer 24. Also shown are connector interface 66 for connection to the removable media port 54, and a reader board connector 68 that is in turn operatively connected to the RFID reader hardware. A external charging connection 72 may also be provided. This illustration is just one embodiment of the manner in RFID which a handheld computer may be adapted to interface with the RFID reader of the present invention.

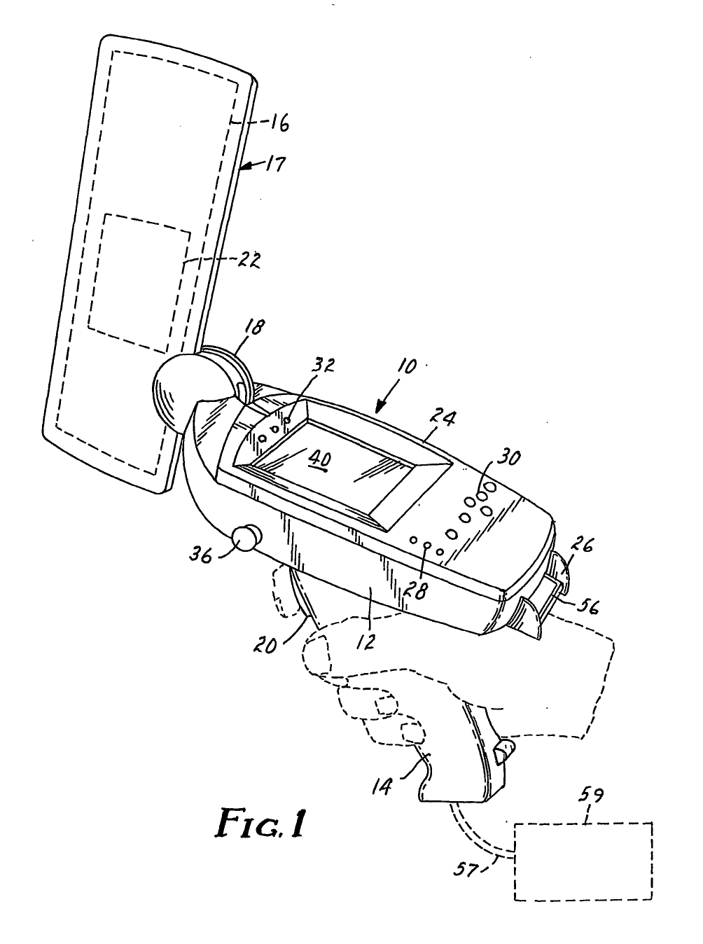

One specific aspect of the present invention relates to the type of memory used to store information for and provide information to the RFID reader. The RFID reader of the present invention includes a removable data storage medium 56, which is preferably non-volatile, for the storage of information. The term “removable” means readily removable by a user, without the use of tools, so that the user can readily reconnect the medium to an interface (such as a port or drive, as described below) associated with another device. FIG. 2 illustrates a user removing removable data storage medium 56 from a port 26 provided, in this illustration, near the back of the RFID reader. The term “non-volatile” describes memory that retains its stored information even when disconnected from a source of power. Non-volatile removable memory enables a user to physically remove the memory from the RFID reader, to reconnect the memory to the RFID reader or to another compatible device, or to lose all power to the RFID reader, all without any loss of information stored on the removable medium.

One preferred general type of removable non-volatile data storage medium is a solid state data storage medium (meaning one without moving parts) that uses flash technology (referred to herein as a flash memory card), one example of which is currently sold by the SanDisk Corporation of Sunnyvale, Calif., or at “www.sandisk.com,” under the designation COMPACTFLASH™ (or CF™). These flash memory cards currently range in storage capacity from 8 MB to 512 MB, do not include a battery, have a 50 pin connector, are supported by numerous platforms and operating systems, and are claimed by at least one source to be suitable for normal use for more than 100 years with no loss or deterioration of data. More information related to COMPACTFLASH™ memory cards is currently available at www.compactflash.org. Other embodiments of removable, non-volatile memory include those currently sold under the designation MEMORY STICK™ by the Sony Corporation of Tokyo, Japan, which currently have a storage capacity of 4-64 MB; those currently sold under the designation MICRODRIVE™ by International Business Machines (IBM) of Armonk, N.Y., which currently have a storage capacity of 340 MB to 1 GB; floppy disks; optically-recorded media (preferably re-recordable optical media); or the like.

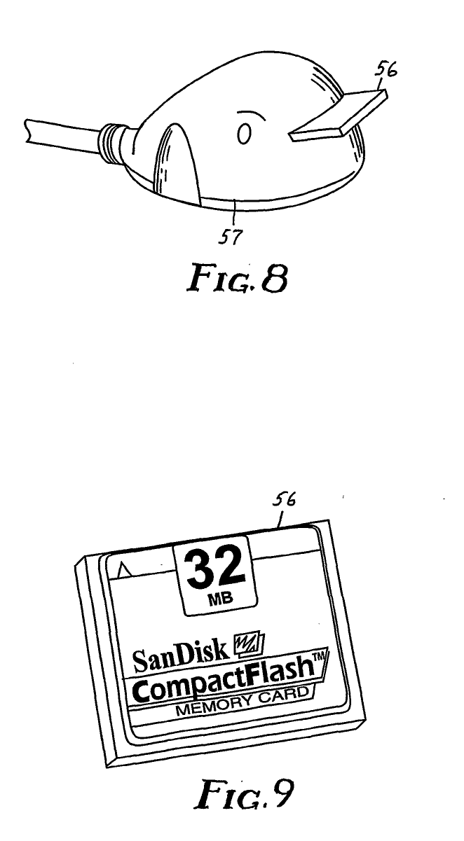

The non-volatile removable medium may be inserted into a port or drive to read information from or write information onto the media. The term “port” will for convenience be used to refer to the receiving interface on the RFID reader, and the term “drive” will for convenience be used to refer to the receiving interface on, in, or connectable to other devices, such as a drive associated with a personal computer. Drives such as drive 75, shown in FIG. 8, are typically provided by the manufacturer of the removable medium and can be connected to a standard PC and made to operate using conventional software. One such example is the card reader/writer for desktop computers, which is currently available from SanDisk Corporation under the designation “IMAGEMATE™ COMPACTFLASH™”. Reader/writers of this type are currently available with either parallel port or USB connections for personal computers, and either may be acceptable. By using a reader/writer such as the ones just referenced, a personal computer may be adapted to download data to the removable media or upload data from it. Data that are uploaded to a personal computer (or a handheld computer, cellular telephone, or other computing device) may be stored in or used to update data in a database, or compared to data already in a database.

The removable data storage medium 56 can also be inserted into a port 26 provided in an RFID reader, and thereby enable the RFID reader to read information from or write information to the removable media, or both. In one embodiment, the port may be integral with the display and processor, as with the TRGPRO™ referenced above, which includes a flash memory card port. The port may be positioned in one of a number of locations on the RFID reader, one of which is shown in FIGS. 1 and 2. The type of port or drive into which the removable media is inserted or placed must be compatible with the type of media to be used, so that an optically recorded medium is positioned in a port, having an optical reader, a magnetic medium is positioned in a port having a magnetic media reader, or a flash memory card is positioned in a port having a flash memory card reader. Also, removable media that conform to a CF+ specification (more information about which is currently available at www.compactflash.org) can be used with a port on the RFID reader that accepts such CF+ devices, which may include not only a flash memory card such as the CONPACTFLAS™ card, but also magnetic disc cards, and I/O cards. The MICRODRIVE™ referenced above is believed to be a small media/drive system that conforms to the CF+ standard.

If a processor (such as the TRGPRO™) includes its own port, but it is desirable to position the port in a different location on the RFID reader for use by a user, then the two ports may be operatively connected to each other by wiring or other suitable methods. For example, in FIGS. 1 and 2, the port shown at the rear of the RFID reader may be operatively connected to a flash memory port associated with the TRGPRO™ processor and display in the manner illustrated schematically in FIG. 4.

The RFID reader may obtain from the removable data storage medium not only information that describes an RFID tag or the object to which it is attached, or both, but also information used to activate one or more lights, or graphics on the display, or sounds produced, in regard to that information. In addition or in place of obtaining information from the removable media to activate these components of a user interface or for other purposes, information may be obtained from the tag, from on-board processor memory, or from any combination of them.

The RFID reader of the present invention has many beneficial uses. In one embodiment, the RFID reader may be configured for use in a library. A computer may be used to write data to the removable, non-volatile data storage medium including, for example, the full title, author and call number for each library item of interest. The data storage medium may then be removed from the reader/writer and inserted into the RFID reader. When the data storage medium is connected to the RFID reader, the RFID reader has access to the data stored on that storage medium as the RFID tags associated with various library items are interrogated and identified by the RFID reader. An indication of the presence or absence of those materials may be provided to the user in any appropriate manner.

The RFID reader may also collect data obtained by interrogating library materials, and download all or a portion of those data to the data storage medium, and those data written to the removable data storage medium may be subsequently uploaded to a computer. The RFID reader of the present invention may be used for other applications in which it is useful to interrogate RFID tags, in environments such as retail stores.

The use of removable media, and preferably non-volatile media, overcomes the limitations in conventional memory that is typically available with handheld processors, and also allows the user to easily change databases as needed. That is, a user may download from a computer a certain database to the removable media, place that removable media into an RFID reader, and then use the reader only in regard to that certain database. If the removable media is of the flash memory type, for example, another advantage is the reduction in download time required to transfer information from a computer to the removable media when compared to other methods of data transfer. Using a small flash memory card (or similar) allows a user to transport a small, lightweight object eliminating the need to connect the entire RFID interrogator to a docking station to transfer data. Also, because current handheld RFID readers have limited memory available (8 MB, for example), a removable, non-volatile data storage medium greatly expands the size of a database available to the RFID reader. Lastly, flash memory cards are said by at least one source to use only 5% of the power required to operate a small disc drive (such as a 1.8 inch (4.57 cm) or 2.5 inch (6.35 cm) disk drive), and therefore can be used for longer periods of time with the same amount of battery power, or for the same amount of time with a smaller battery, if that type of removable memory is selected.

Another advantage of the RFID reader of the present invention is the ability to provide information to a user in “real time.” That is, information can be processed by the RFID reader and provided to a user using integral data storage, without having to transfer information back to a database separate from the RFID reader or receive information from such a database. The transfer of information between an RFID reader and a database separate from the RFID reader (whether by wireless or wired connection, or by a docking station for the RFID reader, for example) is a relatively slow process. The present invention overcomes those problems without sacrificing data storage capacity by using integral (and preferably removable) data storage media of the type described. Accordingly, the methods of using the RFID reader described herein (including the documents incorporated herein) can be used to provide information to a user in real time based on data that is stored on a medium that is either a permanent part of the RFID reader, removable from a port on the RFID reader, or tethered to the RFID reader, which is a significant benefit.

The RFID reader of the present invention is also believed to be useful in performing one or more of the methods described in published PCT applications WO 00/10144 (entitled “Applications for Radio Frequency Identification Systems”) and WO 00/10122 (entitled “Radio Frequency Identification Systems Applications”), the contents of both of which are incorporated by reference herein, and both of which are assigned to the assignee of the present invention. Thus, for example, the RFID reader of the present invention could be used to download a list of items of interest to the removable data storage medium described herein, and then to interrogate various RFID-tagged items to determine whether any of those items are among those on the list. Each time the RFID reader interrogates such an item, it may provide through the user interface an indication that the item has been located. In another embodiment, the RFID reader of the present invention could be used to verify the order of items located on, for example, a shelf The reader would be able to access software that would provide the reader with an ordered set of items, or an algorithm indicative of an order, and the reader could then determine whether the interrogated items were in the algorithm order. In yet another embodiment, the RFID reader could be used for “sweeping,” meaning that the RFED tags associated with items may be interrogated and information regarding those items transferred to a database (perhaps on the removable data storage medium of the present invention) for use in generating statistical profiles of the usage of the items based on how many times the item has been interrogated during sweeping. Other such functions are described in the documents incorporated by reference above.

Other uses of the RFID reader of the present invention may be for interrogating RFID tags associated with evidence for law enforcement (in, for example, an evidence storage room in which multiple pieces of RFID-tagged evidence are kept for use by law enforcement authorities), or with files (in file rooms, cabinets, or the like) to enable the user to locate a particular file, or a file that is out of order or lost, or is otherwise of interest to the user. In another embodiment, the RFID reader of the present invention may be used to interrogate an RFID tag associated with a package (such as a cardboard box or other container), interrogate an RFID tag associated with at least one tagged item within the package, and then to compare the information obtained from each tag (and perhaps from a database having an entry correlating the package tag to the items within the package, such as a database contained on the removable data storage medium) to verify the contents of the package. For example, the tag associated with the package may indicate that it contains 5 audio tapes, each of which is separately tagged with an RFID tag. The RFID reader can be used to verify that the package does contain 5 audio tapes in the manner described.

We claim:

1. An RFID reader for interrogating and obtaining information from an RFID tag, and for obtaining information from a removable data storage medium, the RFID reader including a port for receiving the removable data storage medium.

2. The RFID reader of claim 1, wherein the RFID reader is adapted to obtain information from the RFID tag and write at least a portion of that information to a removable data storage medium positioned within the port.

3. The RFID reader of claim 1, wherein the data storage medium is solid-state.

4. The RFID reader of claim 3, wherein the solid-state data storage medium is a flash memory card.

5. The RFID reader of claim 1, wherein the port is adapted to receive a magnetic media cartridge.

6. The RFID reader of claim 1, wherein the port is adapted to receive an optically-recorded disc.

7. The RFID reader of claim 1, wherein the port is adapted to receive media that conform to the CF+ standard.

8. The RFID reader of claim 2, wherein the reader is adapted to record information onto an optically-recorded disc.

9. The RFID reader of claim 1, wherein the reader is adapted to record information onto a magnetic media cartridge.

10. The RFID reader of claim 1, wherein the reader includes a user interface having a display on which at least one graphic associated with an item of interest may be presented for observation by a user.

11. The RFID reader of claim 1, wherein the reader includes a user interface having a display on which text associated with an item of interest may be presented for observation by a user.

12. The RFID reader of claim 1, wherein the reader includes a user interface which is adapted to provide at least one audio signal for providing information to the user.

13. The RFID reader of claim 11, wherein the audio signal is provided when the RFID tag of an item meeting a predetermined criterion is interrogated.

14. The RFID reader of claim 13, wherein the predetermined criterion is selected from a group consisting of:
(a) a specific RFID tag associated with an item of interest;
(b) an RFID tag that is out of order relative to the RFID tag of at least one adjacent item; and
(c) a class of items to which the item of interest belongs.

15. The RFID reader of claim 1, wherein the reader includes a user interface having at least one light for providing information to the user.

16. The RFID reader of claim 15, wherein the light is only illuminated when the RFID tag of an item meeting a predetermined criterion is interrogated.

17. The RFID reader of claim 16, wherein the predetermined criterion is selected from a group consisting of:
(a) a specific RFID tag associated with an item of interest;
(b) an RFID tag that is out of order relative to the RFID tag of at least one adjacent item; and
(c) a class of items to which the item of interest belongs.

18. The RFID reader of claim 1, wherein the reader comprises a user interface in which an interrogation area is shown on the display as a first graphical component of the user interface, and an item of interest is shown on the display as a second graphical component of the user interface relative to the first graphical component to indicate a location within the interrogation area.

19. The RFID reader of claim 18, wherein the first graphical component is a bar, and the second graphical component is a portion of the bar.

20. The RFID reader of claim 19, wherein the first graphical component is a series of icons, and the second graphical component is one of the icons of the series, in which the one icon is visually differentiated from the remainder of the icons.

21. The RFID reader of claim 1, wherein the reader includes a user interface in which the user can select an item represented on the display, and thereby cause the RFID reader to provide a signal when the RFID tag associated with that item has been interrogated.

22. The RFID reader of claim 1, wherein the user interface enables a user to select more than one item represented on the display, and thereby cause the RFID reader to provide a signal when the RFID tag associated with any of the selected items has been interrogated.

23. In combination:
(a) an RFID reader for interrogating and obtaining information from an RFID tag, the RFID reader having a port for receiving a removable data storage medium; and
(b) a removable data storage medium, wherein the RFID reader is adapted to read information from the removable data storage medium.

24. The combination of claim 23, wherein the removable data storage medium is a non-volatile data storage medium.

25. The combination of claim 23, wherein the RFD reader is further adapted to write information to the data storage medium.

26. The combination of claim 23, wherein the removable data storage medium is a flash memory storage device.

27. The combination of claim 23, wherein the removable data storage medium is a magnetic media cartridge.

28. The combination of claim 23, wherein the removable data storage medium is an optically-recorded disc.

29. The combination of claim 23, further comprising (c) a computer including a drive for receiving the removable data storage medium, so that information can be uploaded to the computer from the data storage medium or downloaded from the computer to the data storage medium, or both.

30. The combination of claim 29, further comprising (d) a database that can be updated by the computer with information from the removable data storage medium.

31. The transfer of information from a computer database to a removable non-volatile data storage medium to an RFID reader for use with information obtained by the RFID reader from the interrogation of RFID tags.

32. The transfer of information from (a) an RFID tag to (b) an RFID reader interrogating that tag to (c) a removable non-volatile data storage medium to (d) a database.

33. The use of a removable, non-volatile data storage medium with an RFID reader, the RFID reader adapted to obtain information from the data storage medium.

34. The use of a removable, non-volatile data storage medium with an RFID reader adapted to write information to the data storage medium.

35. The use of a removable, non-volatile data storage medium with an RFID reader, the RFID reader adapted to both obtain information from and write information to the data storage medium.

36. A method of providing information to an RFID device, comprising the steps of:
(a) downloading information from a computer to a removable data storage medium; and
(b) connecting the removable data storage medium to a port on the RFID device, whereby the RFID device can obtain the information from the removable data storage medium.

37. The method of claim 36, wherein the removable data storage medium is a non-volatile data storage medium.

38. The method of claim 36, wherein the method further comprises the step of (c) interrogating RFID tags associated with individual items to obtain information from the tags.

39. The method of claim 36, wherein the method further comprises the step of (c) interrogating RFID tags associated with library materials to obtain information from the tags.

40. The method of claim 36, wherein the method further includes the step of (c) interrogating RFID tags associated with consumer goods to obtain information from the tags.

41. The method of claim 36, wherein the method further includes the step of (c) interrogating RFID tags associated with evidence for law enforcement to obtain information from the tags.

42. The method of claim 36, wherein the method further includes the step of (c) interrogating RFID tags associated with files to obtain information from the tags.

43. The method of claim 36, wherein the method further comprises (c) interrogating an RFID tag associated with a package to obtain information relating to items contained within the package; (d) interrogating an RFID tag associated with at least one item within the package; and (e) comparing the information obtained in steps (c) and (d) to verify the contents of the package.

44. The method of claim 36, wherein the method further comprises (c) interrogating an RFID tag associated with a package; (d) interrogating an RFID tag associated with at least one item within the package; and (e) comparing the information obtained in steps (c) and (d) using a database correlating the package tag to the items within the package to verify the contents of the package.

45. The method of claim 43, wherein the package is a carton, and the items are individual items packaged within the carton for transfer therein.

46. The method of claim 36, wherein the computer further includes a drive operatively connected to the computer, and the method includes a step prior to step (a) of inserting the removable data storage medium into the drive.

47. The method of claim 36, wherein the method further includes the step of (c) uploading information from the removable data storage medium to memory associated with the RFID reader.

48. The method of claim 47, wherein the method further includes the step of (d) writing information from the RFID reader onto the removable data storage medium.

49. A method of using an RFID reader, comprising the steps of:
(a) interrogating an RFID tag;
(b) storing information related to the interrogated RFID tag on a removable data storage medium; and
(c) removing the removable data storage medium from the RFID reader.

50. The method of claim 49, wherein the method further includes the steps of (d) connecting the removable data storage medium with a drive associated with a computer; and (e) uploading information from the data storage medium to the computer.

51. The method of claim 50, wherein the method further comprises the step of (f) updating a computer database using the information.

52. The method of claim 51, wherein the information describes an item to which the RFID tag is attached.

53. The method of claim 52, wherein the item is a library material, a consumer good, a piece of evidence obtained by law enforcement, or a file.

54. A portable RFID reader for interrogating and obtaining information from an RFID tag, the RFID reader having a user interface and a removable data storage medium containing information related to multiple items each bearing an RFID tag, the RFID reader and data storage medium adapted to provide, in real time and through the user interface, information related to items that are interrogated by the RFID reader.

55. The portable RFID reader of claim 54, wherein the removable data storage medium comprises a non-volatile data storage medium operatively connected to a port.

56. The portable RFID reader of claim 54, wherein the data storage medium is a flash memory card.

57. The portable RFID reader of claim 54, wherein the information is an inventory list.

58. The portable RFID reader of claim 57, wherein the inventory list is a list of library materials.

59. The portable RFID reader of claim 57, wherein the inventory list is a list of consumer goods.
